(19) United States
(12) Patent Application Publication
(10) Pub. No.: US 2017/0206733 A1
(43) Pub. Date: Jul. 20, 2017

(54) FOOD VENDING MACHINE AND OPERATION METHOD THEREOF

(71) Applicant: Pen-Chun YU, Hualien City (TW)

(72) Inventor: Pen-Chun YU, Hualien City (TW)

(21) Appl. No.: 15/296,986

(22) Filed: Oct. 18, 2016

(30) Foreign Application Priority Data
Jan. 20, 2016 (CN) 201610036104.7
Jan. 20, 2016 (CN) 201610036106.6

(51) Int. Cl. G07F 17/00; A23L 5/10

(52) U.S. Cl. CPC G07F 17/0014; A23L 5/10; A23V 2002/00

(57) ABSTRACT

A food vending machine has a chassis, multiple storing devices, a food accessing device, a foodbox device, a packaging device, a processing stage, a transporting device and a freezing device. The chassis has an internal space defined therein. The storing devices, food accessing device, foodbox device, packaging device, processing stage, transporting device and freezing device are mounted in the internal space. A customer may order specific foods by operating the food vending machine to implement a selecting act, a paying act, a cooking act, a food filling act, a seasoning act, a packaging act and a picking up act. The food vending machine allows customers to cook customized refresh foods on site. Furthermore, the cooked foods are put a foodbox without intervening refrigerating or freezing processes between the cooking process and food filling process, which prevents the cooked foods from deteriorating and keeps the customers' in good health.

### BACKGROUND OF THE INVENTION

### 1. Field of the Invention

The present invention relates to a vending machine, and more particularly to a food vending machine that cooks fresh raw foods on site and an operation method of the food vending machine.

### 2. Description of Related Art

Two common conventional types of providing fast foods merchandises are fast food restaurants and instant food sales. First, fast food restaurants are able to provide cooked foods and allow each customer to order foot sets or foods a la carte. Therefore, flexibility to choose foods is excellent in such fast food restaurants. However, due to limitations of locations and funds, a fast food restaurant is not certainly set in a populous area, which is inconvenient for customers. Furthermore, during cooking and packaging processes, cooks or kitchen may have hygiene issues that probably contaminate foods. Second, instant foods such as instant noodles are conveniently portable and made with variety of tastes. Moreover, sales channel of instant foods are extensive such that people may easily and timely access instant foods in convenience stores or street shops. However, the instant foods have insufficient amount and low nutrition. To prolong the shelf life of instant foods, the instant foods are dehydrated and fried, and seasoning packets thereof are probably added with preservative. Moreover, instant foods need to be processed hot water before, which is inconvenient.

A Chinese patent application No. 201510282330.9 titled “a cooking method for a smart cooking device” discloses a cooking device dispensing foods in bowls and refrigerating in a bowl storing device. By inserting coins, a customer may purchase selected foods. After payment, the selected foods are sent in a microwave zone to heat. The heated foods are sent to an accessible zone for the customer to access the foods.

The aforementioned cooking device may be located in any fields and sites and has higher nutrition in comparison to fast food restaurants. However, the types of foods provided by the cooking device are predetermined and unchangeable. Furthermore, the foods are frozen, microwaved and then dispensed into bowls. The freezing and microwaving processes make the foods have bad taste and easily contains germs causing the foods to deteriorate. Moreover, the dispensed bowls are disposable and generate hazardous material absorbed in foods when microwaved, which endangers the customers.

To overcome the shortcomings, the present invention provides a food vending machine and an operation method thereof to mitigate or obviate the aforementioned problems.

### SUMMARY OF THE INVENTION

The main objective of the invention is to provide a food vending machine that cooks fresh raw foods on site and an operation method of the food vending machine.

A food vending machine in accordance with the present invention comprises: a chassis having an operation panel mounted on the chassis, a partition board mounted in the chassis and has multiple outlet holes defined through the partition board, a refrigeration zone defined in the chassis; a processing zone defined in the chassis, wherein the partition board is formed between the refrigeration zone and the processing zone, and the refrigeration zone communicates with the processing zone through the outlet holes and a packaging zone defined in the chassis; multiple storing devices mounted in the refrigeration zone of the chassis at intervals, connected electrically to the operation panel and corresponding to the outlet holes, and each storing device having a transmission mechanism mounted in the refrigeration zone and multiple carriers mounted detachably on the transmission mechanism and selectively driven by the transmission mechanism to move in circulation; a food accessing device mounted in the processing zone of the chassis and connected electrically to operation panel; a foodbox device mounted in the packaging zone of the chassis and connected electrically to the operation panel; a packaging device mounted in the packaging zone of the chassis and connected electrically to the operation panel; a processing stage mounted in the processing zone of the chassis, abutting the partition board and located below the accessing device; a transporting device mounted in the packaging zone of the chassis; and a freezing device is mounted in the refrigeration zone of the chassis.

An operation method for operating the food vending machine in accordance with the present invention comprises: a selecting act being selecting one of raw food and selecting one of cooking modes defined in the food vending machine through the operation panel of the food vending machine; a paying act being calculating a total price through the operation panel based on the selected raw food and the selected cooking mode and allowing a customer to pay off by choosing one of payment ways; a cooking act being sending the selected raw food through the food accessing device to the at least one cooking device to cook the selected raw food; a food filling act being filling a corresponding foodbox with the cooked food through the food accessing device; a packaging act being moving the filled foodbox through the food transporting mechanism to the packaging device to package the filled foodbox; and a picking up act being moving the packaged foodbox through the food transporting mechanism to the accessing opening such that the customer is able to pick up the foodbox.

An operation method for operating a food vending machine in accordance with the present invention comprises: a selecting act being selecting one of raw food and selecting one of cooking modes; a paying act being allowing a customer to pay off based on the selected raw food and the selected cooking mode; a cooking act being cooking the selected raw food; a food filling act being filling a corresponding foodbox with the cooked food; a packaging act being packaging the filled foodbox; and a picking up act being allowing the customer to pick up the foodbox.

The food vending machine allows customers to cook customized refresh foods on site. Furthermore, the cooked foods are put a foodbox without intervening refrigerating or freezing processes between the cooking process and food filling process, which prevents the cooked foods from deteriorating and keeps the customers' in good health.

Other objectives, advantages and novel features of the invention will become more apparent from the following detailed description when taken in conjunction with the accompanying drawings.

### BRIEF DESCRIPTION OF THE DRAWINGS

FIG. 1 is a perspective of a food vending machine in accordance with the present invention;

FIG. 2 is another perspective view of the food vending machine in FIG. 1;

FIG. 3 is an exploded perspective view of the food vending machine in FIG. 1;

FIG. 4 is a perspective of a cooking device of the food vending machine of FIG. 1; and

FIG. 5 is a flow chart of an operation method for operating the food vending machine in accordance with the present invention.

### DETAILED DESCRIPTION OF THE PREFERRED EMBODIMENT

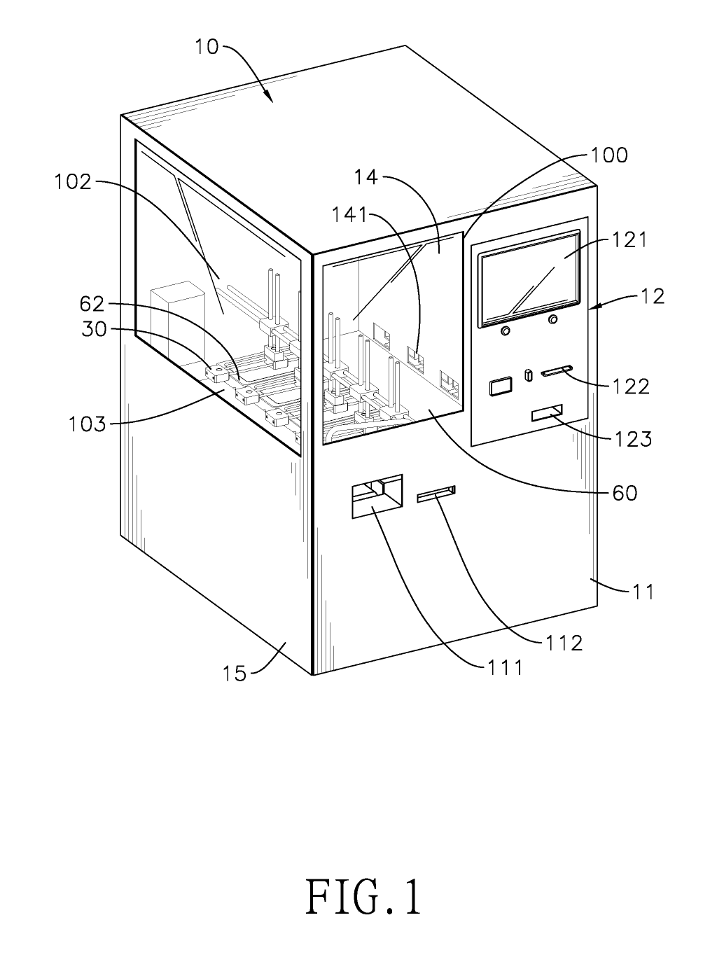

With reference to FIGS. 1 to 3, a food vending machine has a chassis 10, multiple storing devices 20, a food accessing device 30, a foodbox device 40, a packaging device 50, a processing stage 60, a transporting device 70 and a freezing device 80.

The chassis 10 has an electrical control unit (not shown), an internal space 115, a front wallboard 11, an operation panel 12, a first side wallboard 13, a partition board 14, a second wallboard 15, a third wallboard 16, a refrigeration zone 101, a processing zone 102, a packaging zone 103 and multiple transparent glasses 100.

The electrical control unit is electrically connected to an external power supply for accessing necessary electricity.

The internal space 115 is defined in the chassis 10.

The front wallboard 11 is mounted on the chassis 10 and has a food accessing opening 111, a utensil accessing opening 112 and a utensil storing device 110. The food accessing opening 111 and the utensil accessing opening 112 are defined through the front wallboard 11 at an interval and communicate with the internal space 115 of the chassis 10. The utensil storing device 110 is mounted on the front wallboard 11 in the internal space 115, is located opposite to the utensil accessing opening 112, is connected electrically to the operation panel 12 and may receive utensil packages. The utensil storing device 110 has an auto gate that is capable of opening and closing. When the auto gate opens, a utensil package is fallen out of the gate to the utensil accessing opening 112. The utensil storing device 110 belongs to conventional art and is not necessarily to be further described in details.

The operation panel 12 is mounted on the front wallboard 11, is connected electrically to the utensil storing device 110 and has a screen 121, a payment device 122 and a change zone 123. Furthermore, the operation panel 12 may be built with a micro computer and installed with a software system to implement order inputted by customers. Thus, the operation panel 12 may have multiple cooking modes for cooking different foods.

The screen 121 is mounted on the operation panel 12 and may be a touch screen having multiple operation keys.

The payment device 122 is connected electrically to the screen 121, is capable of generating binary code, is connected electrically to the utensil storing device 110 and has a coin insertion slot, a paper currency insertion slot, a credit card slot and a magnetic card sensing zone. Specifically, a customer, through the payment device 122, may pay by coins, paper currency, a credit card or a smart phone scanning the binary code. The food vending machine may also be connected to social or governmental welfare institutes to allow disadvantaged groups to pay by monthly tickets or passwords. After the customer pays by the payment device 122, the payment device 122 sends a signal to and drives the utensil storing device 110 to open the auto gate to dispense a utensil packages.

The change zone 123 is formed on the operation panel 12 and communicates with the payment device 122. The operational panel 12 belongs to conventional art and is not necessarily to be further described in details

The first side wallboard 13 is mounted on one of two sides the chassis 10 adjacent to one of two side edges of the front wallboard 11.

The partition board 14 is formed in the internal space 115 of the chassis 10, is arranged with the first side wallboard 13 at an interval to define the refrigeration zone 101 and has multiple outlet holes 141. The outlet holes 141 are defined through the partition board 14.

The second side wallboard 15 is mounted on the other one of the sides of the chassis 10 and is located adjacent to the other one of the side edges of the front wallboard 11. The second wallboard 15 is arranged with the partition board 14 at an interval to define the processing zone 102 and the packaging zone 103.

The third wallboard 16 is mounted on the chassis 10, is connected to the second side wallboard 15, the partition board 14 and the first side wallboard 13, is located opposite to the front wallboard 11 to form the processing zone 102 and the packaging zone 103 in the chassis 10.

The refrigeration zone 101 is defined between the first side wallboard 13 and the partition board 14. The refrigeration zone 101 is used for refrigerating raw foods.

The processing zone 102 is defined between the partition board 14 and the second wallboard 15 and communicates with the refrigeration zone 101 through the outlet holes 141. The raw foods in the refrigeration zone 101 may be transported to the processing zone 102 through the outlet holes 141.

The packaging zone 103 is defined between the partition board 14 and the second wallboard 15.

The transparent glasses 100 are two, are mounted respectively on the front wallboard 11 and the second side wallboard 15. The transparent glasses 100 allow the customer to clearly observe the processing zone 102 and the packaging zone 103 and ensure the sealing characteristics and hygiene of the chassis 10.

The storing devices 20 are mounted in the refrigeration zone 101 of the chassis at intervals, are connected electrically to the operation panel 12 and correspond to the outlet holes 141. Each storing device 20 has a transmission mechanism 21 and multiple carriers 22.

The transmission mechanism 21 is a looped chain device, is mounted in the refrigeration zone 101and has multiple boxes 211 mounted on the transmission mechanism 21 at intervals. The boxes 211 are driven by the transmission mechanism 21 to revolve.

The carriers 22 are hollow and detachably mounted respectively in the boxes 21 of the transmission mechanism 21 and are selectively driven by the transmission mechanism 21 to move in circulation. Each box 211 and corresponding carrier 22 may move to align with a corresponding outlet hole 141 of the partition board 14 during the rotation of the transmission mechanism 21. The storing devices 20 are belong to conventional art.

The food accessing device 30 is mounted in the processing zone 102 of the chassis 10, is connected electrically to operation panel 12 and has a rail bar assembly 300 and at least one accessing unit 31, 32, 33, 34 or 35.

The rail bar assembly 300 is mounted between the third side wallboard 16 and the first side wallboard 11.

Preferably, the at least one accessing unit 31, 32, 33, 34 or 35 may be multiple accessing units 31, 32, 33, 34 and 35 that are capable of accessing and cook variety of raw foods. The at least one accessing unit 31, 32, 33, 34 or 35 is mounted movably on the rail bar assembly and is capable of moving three-dimensionally. The at least one accessing unit 31, 32, 33, 34 or 35 may be robotic arms. The at least one accessing unit 31, 32, 33, 34 or 35 belongs to conventional art.

The foodbox device 40 is mounted in the packaging zone 103 of the chassis 10, may be mounted on the third side wallboard 13, is connected electrically to the operation panel 12 and has multiple foodboxes 41. The foodboxes 41 are mounted in the foodbox device 40. When receiving signals from the operation panel 12, the foodbox device 40 releases a foodbox 41. The foodbox device 40 belongs to conventional art.

The packaging device 50 is mounted in the packaging zone 103 of the chassis 10, is connected electrically to the operation panel 12, and is capable of covering and packaging. The packaging device 50 may be a package sealer. The packaging device 50 belongs to conventional art.

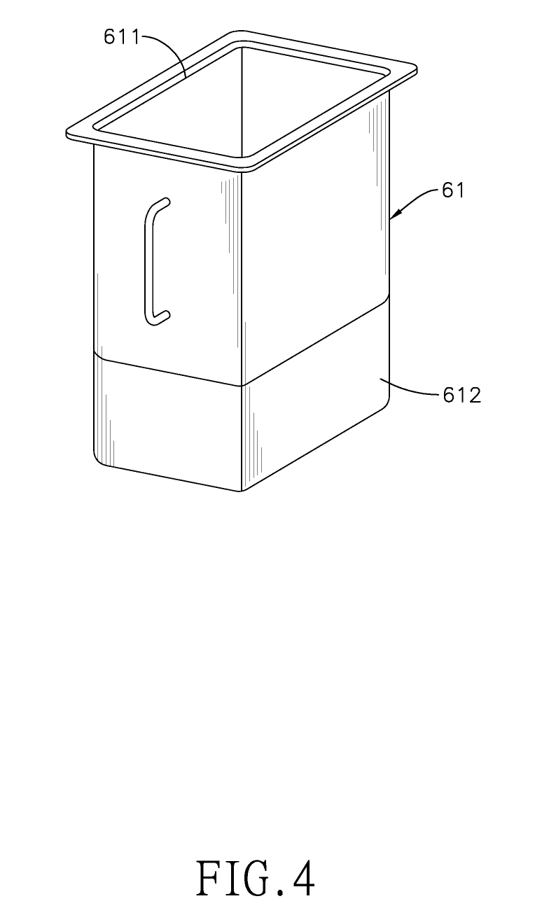

With reference to FIGS. 1, 3 and 4, the processing stage 60 is mounted in the processing zone 102 of the chassis 10, abuts the partition board 14, is located below the accessing device 30 and has at least one cooking device 61, 62, 63, 64 or 65 and a seasoning device 600.

The at least one cooking device 61, 62, 63, 64 or 65 is mounted detachably and modularly on the processing stage 60 and may be multiple cooking devices 61, 62, 63, 64 and 65. Each of the at least one cooking device 61, 62, 63, 64 or 65 has a pot 611 and a heater 612.

The pot 611 is mounted detachably on the processing stage 60.

The heater 612 is mounted on a bottom of the pot 611.

Preferably, the cooking devices 61, 62, 63, 64 and 65 are arranged in series on the processing 60 and may be added with water or cooking oil for cooking different dishes. The heater 612 may be a thermoelectric heater, gas heater, or induction cooker based on different cooking modes of the cooking devices 61, 62, 63, 64 and 65. The at least one cooking device 61, 62, 63, 64 or 65 is not limited to heat raw foods but also can make cold foods such as sashimi or fruit smoothies.

The seasoning device 600 is mounted on the processing stage 60, is located in the packaging zone 103 and is connected electrically to the operation panel 102. Controlling the operation panel 102 may drive the seasoning device 600 to release seasoning.

The transporting device 70 is mounted in the packaging zone 103 of the chassis 10 and has a food transporting mechanism 71 and a carrier transporting mechanism 72. Specifically, the food transporting mechanism 71 and carrier transporting mechanism 72 are conventional transporting belt devices.

The food transporting mechanism 71 is arranged with the processing stage 60 in parallel and is aligned with the food accessing opening 111. One of two ends of the food transporting mechanism 71 is located below the seasoning device 600 of the processing stage 60 and corresponds to the packaging device 50. The other end of the food transporting mechanism 71 faces the third side wallboard 16 and correspond to the foodbox device 40. The food transporting mechanism 71 rotates from the third side wallboard 16 to the front wallboard 11.

The carrier transporting mechanism 72 is arranged with the food transporting mechanism 71 in parallel. One of two ends of the carrier transporting mechanism 72 faces the front wallboard 11 and the other end of the carrier transporting mechanism 72 faces the third side wallboard 16. The carrier transporting mechanism 72 rotates from the front wallboard 11 to the third side wallboard 16. The carrier transporting mechanism 72 has a carrier collection portion 721. The carrier collection portion 721 is mounted securely on the third side wallboard 16 and is aligned with the carrier transporting mechanism 72. The carrier transporting mechanism 72 rotates toward the carrier collection portion 721. The carrier collection portion 721 is capable of collecting and recycling the empty and used carriers 22.

The refrigeration zone 101 is used to accommodate raw foods, crushed ice or ice cream ingredients. The selected raw foods are transported through the outlet holes 141 of the partition board 14 to the processing stage 60 of the processing zone 102. The at least one cooking device 61, 62, 63, 64 or 65 of the processing stage 61 processes the raw foods. The processed foods are packaged by the foodbox device 40 and the packing device 50 in the packaging zone 103. Therefore, the foods processed by the food vending machine are hygienic, nutritive and healthy, tasted good and hard to deteriorate.

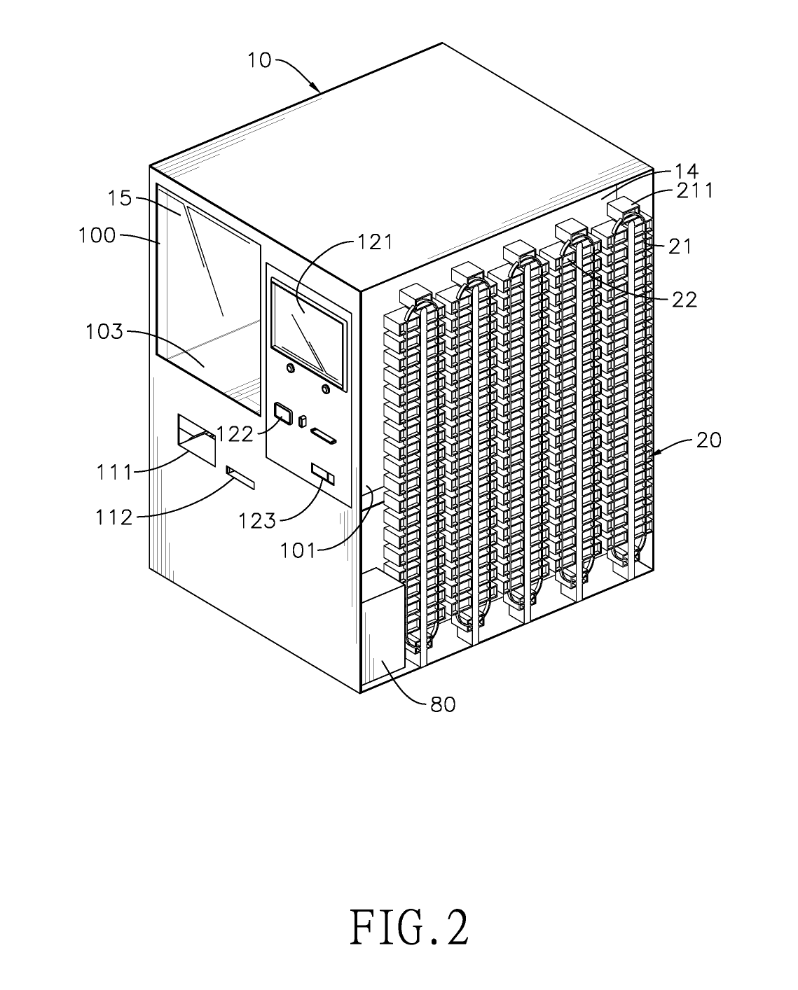

With reference to FIG. 2, the refrigeration zone 101 has five storing devices 20. Each storing device 20 is used for receiving a type of raw foods. For instance, staple foods, vegetable foods, meat foods, egg foods, and seafood are respectively put in the five storing devices 20. The five storing devices 20 correspond to the outlet holes 141 in the partition board 14.

To further distinguish foods in each food type, the aforementioned are equally divided and put respectively in the carriers 22. The transmission mechanisms 21 of the five storing devices 20 circulatingly rotate the carriers 22. When a customer selects the raw foods, a corresponding carrier 22 is rotated to by the transmission mechanism to a corresponding outlet hole 141. The Carriers 22 may have different shapes. For example, the carrier 22 that receives noodles is defined with through holes and is made of metal.

The freezing device 80 is mounted in the refrigeration zone 101. The freezing belongs to conventional art.

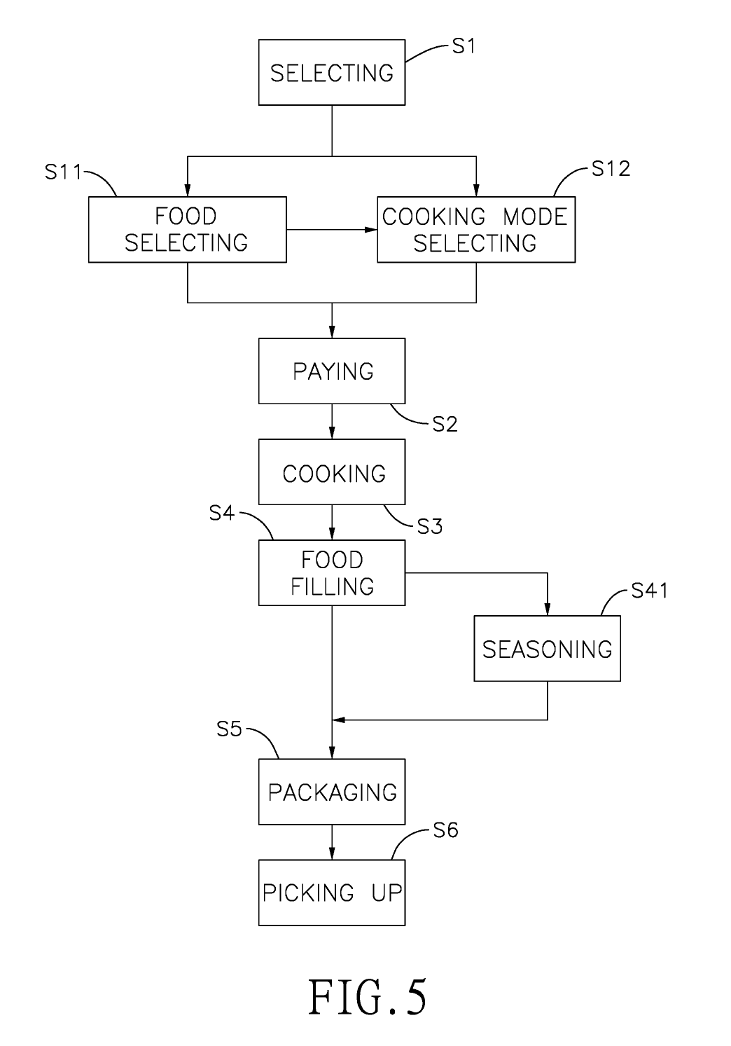

With reference to FIG. 5, an operation method for operating the aforementioned food vending machine in accordance with the present invention comprises a selecting act S1, a paying act S2, a cooking act S3, a food filling act S4, a seasoning act S41, a packaging act S5 and a picking up act S6.

The selecting act S1 is selecting one of raw food and selecting one of cooking modes defined in the food vending machine through the operation panel 12 of the food vending machine. Specifically, the selecting act S1 has a food selecting act S11 and a cooking mode selecting act S12.

The food selecting act S11 is selecting one raw food.

The cooking mode selecting act S12 is selecting one cooking mode for cooking the selected raw food. Specifically, a customer needs to select one raw food and one cooking mode for cooking the selected raw food before he or her select a next raw food and another cooking mode for cooking the next raw food.

The paying act S2 is calculating a total price through the operation panel 12 based on the selected raw food and the selected cooking mode and allowing a customer to pay off by choosing one of payment ways such as coins, paper currency, credit cards or magnetic cards.

The cooking act S3 is sending the selected raw food through the food accessing device 30 to the at least one cooking device 61, 62, 63, 64 or 65 to cook the selected raw food.

The food filling act S4 is filling a corresponding foodbox 41 with the cooked food through the food accessing device 30.

The seasoning act S41 is transporting the filled foodbox 41 through the food transporting mechanism 71 to a position below the seasoning device 600. The seasoning device 600 selectively releases seasoning based on a selection of the customer. During the movement of the foodbox 41 driven by the food transporting mechanism 71, the foodbox 41 is stopped when moving to the position below the seasoning device 600. The customer chooses whether and which seasoning is used through the operation panel 12.

The packaging act S5 is moving the filled foodbox 41 through the food transporting mechanism 71 to the packaging device 10 to package the filled foodbox 41. During the movement of the foodbox 41 driven by the food transporting mechanism 71, the foodbox 41 is stopped when moving to the position below the packaging device 50. The cooked food is put in the foodbox 41 and is seasoned. The packaging device 50 packages the foodbox 41. For example, the foodbox 41 is sealed and covered by the packaging device 50.

The picking up act S6 is moving the packaged foodbox 41 through the food transporting mechanism 71 to the accessing opening 111 such that the customer is able to pick up the foodbox 41.

When the customer pays off, the foodbox device 40 releases one foodbox 41 falling down to a starting operation end of the food transporting mechanism 71. In the meanwhile, the accessing unit 31 of the food accessing device 30 moves along the rail bar assembly 300 to one of the outlet holes 141 that corresponding to one food type. The accessing unit 31 picks up one carrier 22. The carrier 22 includes a specific raw food of the food type that is selected by the customer.

The accessing unit 31 moves the carrier 22 to the cooking device 61 to cook the food. After cooking, the accessing unit 31 takes the carrier 21 out of the cooking device 61, and the food transporting mechanism 71 moves the carrier 22 to the position over the foodbox 41 and pour the food such as staple foods in the carrier 22 in the foodbox 41. The food transporting mechanism 71 moves the foodbox 41 toward the front wallboard 11 and another food such as vegetable foods or meat foods is poured in the foodbox 41. The empty carrier 22 is moved by the accessing unit 31 over the carrier transporting mechanism 72 and releases the carrier 22. The carrier 22 is fallen on and transported by the carrier transporting mechanism 72 to the carrier collection portion 721. The accessing unit 31 moves back to an original position.

Furthermore, when the customer pays off, the utensil storing device 110 releases a utensil package in the utensil accessing opening 112 to allow the customer to pick it up.

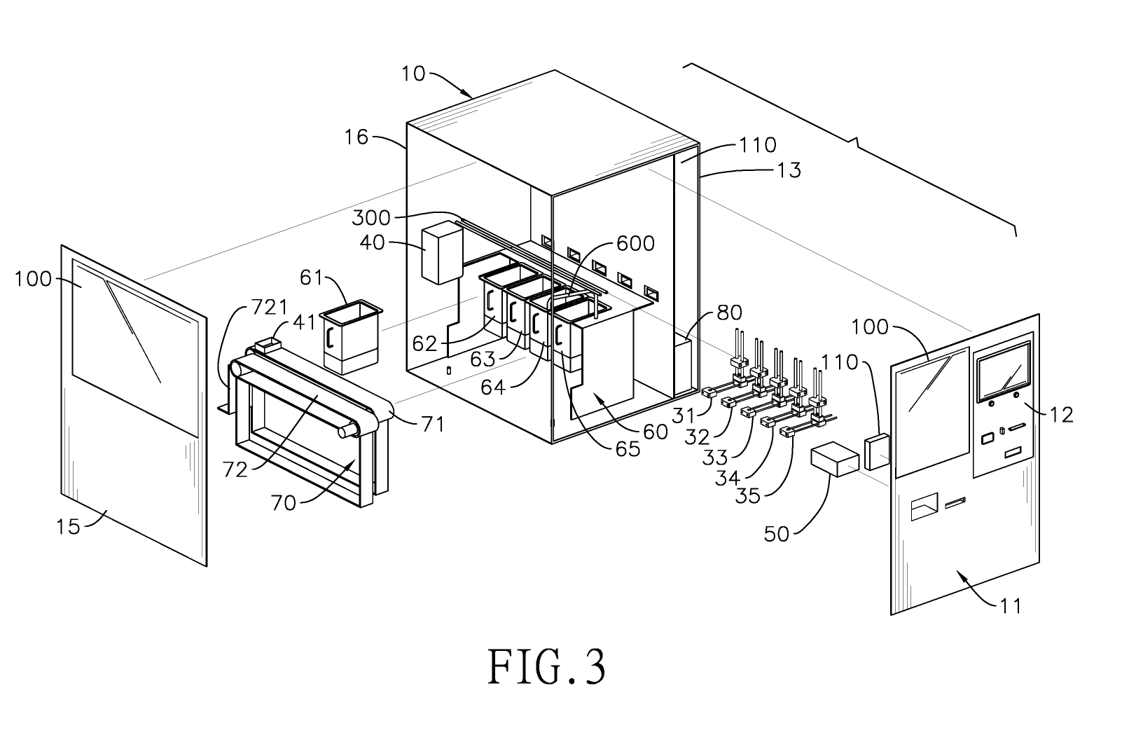

With reference to FIG. 3, the five cooking devices 61, 62, 63, 64 and 65 may be steaming type, boiling type, frying type, pan frying type and oil frying type. A personnel staff managing the food vending machine may change the five cooking devices 61, 62, 63, 64 and 65 according to the area where the food vending machine is set. The frying type cooking device 63 may have a rotation spatula blade to agitate the heated food for frying.

Three examples will be described for explaining operation method for operating the aforementioned food vending machine.

With reference to FIGS. 2, 3 and 5, in a first example, when a customer selects rice, greens, fried beef and omelet, the selecting act S1 is performed by the food vending machine. The customer chooses rice through screen 121 of the operation panel 12 and further selects the cooking mode of steaming performed by the cooking device 61. Then the customer selects greens and further selects the cooking mode of boiling performed by the cooking device 62. The customer selects a beef and further selects the cooking mode of frying performed by the cooking device 63. Finally the customer selects eggs and further selects the cooking mode of pan frying performed by the cooking device 64.

After selections, the operation panel 12 calculates out a total price. The customer pushes a button of the operation panel 12 to generate a binary code and uses a smart phone to scan the binary code to pay off. After payment, the four sets of foods are moved by the transmission mechanisms 21 of the storing devices 20 to the outlet holes 141.

The accessing unit 31 picks up and moves the carrier 22 containing rice in the cooking device 61 to steam the rice. The accessing unit 32 picks up and moves the carrier 22 containing greens in the cooking device 62 to boil the greens. The accessing unit 33 picks up and moves the carrier 22 containing beef in the cooking device 63 to fry the beef. The accessing unit 34 picks up and moves the carrier 22 containing eggs over the cooking device 64 and opens the eggs to make the egg yolk and whites fallen in the cooking device 64 to pan fry the eggs. The food accessing device 30 moves the carrier 22 to the carrier transporting mechanism 72, and the accessing unit 32 picks up the cooked eggs.

The accessing unit 31 holds the carrier 22 filled with the steamed rice and pours the steamed rice to the foodbox 41. The foodbox 41 is mounted on one end of the food transporting mechanism 71 facing the third wallboard 16. The accessing unit 31 moves the carrier 22 to the carrier transporting mechanism 72. The accessing unit 31 moves back to an original position and stands by. The accessing unit 32 holds the carrier 22 filled with the cooked greens and pours the greens to the foodbox 41. The foodbox 41 is mounted on one end of the food transporting mechanism 71 facing the third wallboard 16. The accessing unit 32 moves the carrier 22 to the carrier transporting mechanism 72. The accessing unit 31 moves back to an original position and stands by. The accessing unit 33 puts the beef over the greens. The accessing unit 34 puts the eggs over a top of the foods. Thus, the foodbox 41 is filled completely with the foods.

The foodbox 41 is moved by the food transporting mechanism 71 to the seasoning device 600. The customer seasons the foods in the foodbox 41.

The seasoned foodbox 41 is moved by the food transporting mechanism 71 to the packaging device 50 to seal and package the foodbox 41.

The packaged foodbox 41 moved by the food transporting mechanism 71 to the accessing opening 111 to allow the customer to pick it up.

The empty carriers 22 are put on and moved by the carrier transporting mechanism 72 to the carrier collection portion 721 for recycle.

In a second example, a customer selects beef noodle soup with greens. The customer chooses noodles through the screen 121 of the operation panel 12 and further selects the cooking mode of boiling performed by the cooking device 62. Then the customer selects greens and further selects the cooking mode of boiling performed by the cooking device 62. The customer selects a beef and further selects the cooking mode of frying performed by the cooking device 63.

After selections, the operation panel 12 calculates out a total price. The customer pushes a button of the operation panel 12 to generate a binary code and uses a smart phone to scan the binary code to pay off. After payment, the three sets of foods are moved by the transmission mechanisms 21 of the storing devices 20 to the outlet holes 141.

The accessing unit 31 picks up and moves the carrier 22 containing noodles in the cooking device 62 to boil the noodles. The accessing unit 32 picks up and moves the carrier 22 containing greens in the cooking device 62 to boil the greens. The accessing unit 33 picks up and moves the carrier 22 containing beef in the cooking device 63 to fry the beef. After the beef is fried, the accessing unit 34 picks up the beef.

The accessing unit 31 holds the carrier 22 filled with the noodles and pours the noodles to the foodbox 41. The foodbox 41 is mounted on one end of the food transporting mechanism 71 facing the third wallboard 16. The accessing unit 32 holds the carrier 22 filled with the cooked greens and pours the greens to the foodbox 41. The accessing unit 33 puts the beef over the greens. The accessing unit 34 puts the eggs over a top of the foods. Thus, the foodbox 41 is filled completely with the foods.

The foodbox 41 is moved by the food transporting mechanism 71 to the seasoning device 600. The customer seasons the foods in the foodbox 41 with bone soup or shallot.

The seasoned foodbox 41 is moved by the food transporting mechanism 71 to the packaging device 50 to seal and package the foodbox 41.

The packaged foodbox 41 moved by the food transporting mechanism 71 to the accessing opening 111 to allow the customer to pick it up.

The empty carriers 22 are put on and moved by the carrier transporting mechanism 72 to the carrier collection portion 721 for recycle.

In a third embodiment, raw foods of the food vending machine include staple foods, main ingredients and auxiliary ingredients that are set in three different storing devices 20 that correspond to three outlet holes 141. The staple food is fermented dough shaped into a rounded disk. The main ingredients include washed and chopped ham, bacon and fresh shrimp. The auxiliary ingredients are clean and chopped onions, green peppers, carrots and cheese, etc. The set of ingredients are put respectively in multiple carriers 20. The carriers 20 may be different based on what kind of ingredients is loaded on it. For example the carrier 20 for the dough is a disk. These carriers 22 may be made of metal that is able to be used for cooking.

The processing stage 60 has a cooking device 65 that is an oven. The food vending machine has two accessing units 31 and 32. The foodbox 41 of the foodbox device 40 is a pizza box. The customer requires a six inch ham and bacon pizza with onions, green peppers and cheese. The operation method is as follows.

The customer selects a six inch pizza through the screen 121 of the operation panel 12 and further selects the cooking mode of baking performed by the cooking device 65. The customer selects two sets of main ingredients that one is ham and the other is bacon, and then selects the baking cooking mode. The customer selects two sets of auxiliary ingredients that one is green peppers and the other is cheese, and then selects the baking cooking mode.

After selections, the operation panel 12 calculates out a total price. The customer pays off by put paper currency into the payment device 122 and takes back coin change from the change zone 123. After payment, the three sets of foods are moved by the transmission mechanisms 21 of the storing devices 20 to the outlet holes 141.

The accessing unit 31 holds and moves the carrier 22 contains the dough above the cooking device 65. The accessing unit 32 holds and sprinkles the ham, bacon, green peppers and cheese on the dough. The accessing unit 33 puts the beef over the greens. The accessing unit 31 puts the whole dough in the cooking device 65 for baking.

After the dough is baked to form a pizza, the accessing unit 31 moves the carrier 22 and the pizza out. The pizza is moved into the pizza box and the pizza box is put a starting position of the food transporting mechanism 721.

The seasoned foodbox 41 is moved by the food transporting mechanism 71 to the packaging device 50 to seal and package the foodbox 41.

The packaged foodbox 41 moved by the food transporting mechanism 71 to the accessing opening 111 to allow the customer to pick it up.

The empty carriers 22 are put on and moved by the carrier transporting mechanism 72 to the carrier collection portion 721 for recycle.

The food vending machine allows customers to cook customized refresh foods on site. Furthermore, the cooked foods are put the foodbox 41 without intervening refrigerating or freezing processes between the cooking process and food filling process, which prevents the cooked foods from deteriorating and keeps the customers' in good health.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A food vending machine comprising:
a chassis having
an operation panel mounted on the chassis;
a partition board mounted in the chassis and has multiple outlet holes defined through the partition board;
a refrigeration zone defined in the chassis;
a processing zone defined in the chassis, wherein the partition board is formed between the refrigeration zone and the processing zone, and the refrigeration zone communicates with the processing zone through the outlet holes; and
a packaging zone defined in the chassis;
multiple storing devices mounted in the refrigeration zone of the chassis at intervals, connected electrically to the operation panel and corresponding to the outlet holes, and each storing device having
a transmission mechanism mounted in the refrigeration zone; and
multiple carriers mounted detachably on the transmission mechanism and selectively driven by the transmission mechanism to move in circulation;
a food accessing device mounted in the processing zone of the chassis and connected electrically to operation panel;
a foodbox device mounted in the packaging zone of the chassis and connected electrically to the operation panel;
a packaging device mounted in the packaging zone of the chassis and connected electrically to the operation panel;
a processing stage mounted in the processing zone of the chassis, abutting the partition board and located below the accessing device;
a transporting device mounted in the packaging zone of the chassis; and
a freezing device mounted in the refrigeration zone of the chassis.

2. The food vending machine as claimed in claim 1, wherein the chassis further has
a front wallboard mounted on the chassis and having
a food accessing opening and a utensil accessing opening defined through the front wallboard at an interval and communicating with an internal space of the chassis; and
a utensil storing device mounted on the front wallboard in the internal space, located opposite to the utensil accessing opening and connected electrically to the operation panel;
a first side wallboard mounted on one of two sides the chassis adjacent to one of two side edges of the front wallboard;
a second side wallboard mounted on the other one of the sides of the chassis, located adjacent to the other one of the side edges of the front wallboard and arranged with the partition board 14 at an interval to define the processing zone and the packaging zone;
a third side wallboard mounted on the chassis, connected to the second side wallboard, the partition board and the first side wallboard, located opposite to the front wallboard to form the processing zone and the packaging zone in the chassis; and
two transparent glasses mounted respectively on the front wallboard and the second side wallboard;
the operation panel is mounted on the front wallboard, is connected electrically to the utensil storing device and has
a screen mounted on the operation panel;
a payment device connected electrically to the screen, being capable of generating binary code, connected electrically to the utensil storing device and having a coin insertion slot, a paper currency insertion slot, a credit card slot and a magnetic card sensing zone; and
a change zone formed on the operation panel and communicating with the payment device;
the food accessing device mounted in the processing zone of the chassis, connected electrically to operation panel and having
a rail bar assembly mounted between the third side wallboard and the first side wallboard; and
at least one accessing unit mounted between the third side wallboard and the first side wallboard mounted movably on the rail bar assembly and being capable of moving three-dimensionally.

3. The food vending machine as claimed in claim 2, wherein the transporting device has
a food transporting mechanism arranged with the processing stage in parallel and aligned with the food accessing opening, wherein one of two ends of the food transporting mechanism corresponds to the packaging device, the other end of the food transporting mechanism faces the third side wallboard and correspond to the foodbox device, and the food transporting mechanism rotates from the third side wallboard to the front wallboard; and
a carrier transporting mechanism arranged with the food transporting mechanism in parallel, wherein one of two ends of the carrier transporting mechanism faces the front wallboard and the other end of the carrier transporting mechanism faces the third side wallboard, the carrier transporting mechanism rotates from the front wallboard to the third side wallboard, the carrier transporting mechanism has a carrier collection portion mounted securely on the third side wallboard and aligned with the carrier transporting mechanism, and the carrier transporting mechanism rotates toward the carrier collection portion.

4. The food vending machine as claimed in claim 3, wherein the processing stage has
at least one cooking device mounted detachably and modularly on the processing stage and each cooking device having
a pot mounted detachably on the processing stage; and
a heater mounted on a bottom of the pot; and
a seasoning device mounted on the processing stage, located in the packaging zone and connected electrically to the operation panel.

5. The food vending machine as claimed in claim 4, wherein the processing stage has five cooking devices being steaming type, boiling type, frying type, pan frying type and oil frying type

6. An operation method for operating the food vending machine as claimed in claim 5, comprising
a selecting act being selecting one of raw food and selecting one of cooking modes defined in the food vending machine through the operation panel of the food vending machine;
a paying act being calculating a total price through the operation panel based on the selected raw food and the selected cooking mode and allowing a customer to pay off by choosing one of payment ways;
a cooking act being sending the selected raw food through the food accessing device to the at least one cooking device to cook the selected raw food;
a food filling act being filling a corresponding foodbox with the cooked food through the food accessing device;
a packaging act being moving the filled foodbox through the food transporting mechanism to the packaging device to package the filled foodbox; and
a picking up act being moving the packaged foodbox through the food transporting mechanism to the accessing opening such that the customer is able to pick up the foodbox.

7. The operation method as claimed in claim 6 further comprising a seasoning act implemented after the cooking act and being transporting the filled foodbox through the food transporting mechanism to a position below the seasoning device, wherein:
the seasoning device selectively releases seasoning based on a selection of the customer;
during the movement of the foodbox driven by the food transporting mechanism, the foodbox is stopped when moving to the position below the seasoning device;
a customer chooses whether and which seasoning is used through the operation panel.

8. The operation method as claimed in claim 7, wherein the selecting act has
a food selecting act being selecting one raw food; and
a cooking mode selecting act selecting one cooking mode for cooking the selected raw food

9. An operation method for operating a food vending machine comprising
a selecting act being selecting one of raw food and selecting one of cooking modes;
a paying act being allowing a customer to pay off based on the selected raw food and the selected cooking mode;
a cooking act being cooking the selected raw food;
a food filling act being filling a corresponding foodbox with the cooked food;
a packaging act being packaging the filled foodbox; and
a picking up act being allowing the customer to pick up the foodbox.
